(19) United States
(12) Patent Application Publication
(10) Pub. No.: US 2025/0300470 A1
(43) Pub. Date: Sep. 25, 2025

(54) CIRCUIT, METHOD AND SYSTEM FOR BALANCING THE VOLTAGE OF STORAGE UNITS

(71) Applicant: Torqeedo GmbH, Wessling (DE)

(72) Inventor: Jens BIEBACH, Wessling (DE)

(21) Appl. No.: 19/088,337

(22) Filed: Mar. 24, 2025

(30) Foreign Application Priority Data
Mar. 25, 2024 (DE) 10 2024 108 492.8

(51) Int. Cl. H02J 7/00

(52) U.S. Cl. CPC H02J 7/0019

(57) ABSTRACT

A circuit, a method and a system are provided for balancing the voltage of storage unit connected in series. The circuit corresponds to a ladder network in which horizontal switches form the rungs of the ladder, a storage unit is respectively arranged on the first rail of the ladder between the rungs and a vertical switch is respectively arranged on the second rail between the rungs. By switching the horizontal switches and vertical switches, respective storage units can be connected to a balancing source so that the latter adjusts the voltage of the connected storage unit, whereby the voltage of the storage units in the series connection is balanced.

### CROSS REFERENCE TO RELATED APPLICATIONS

The current application claims priority to German Patent Application DE 10 2024 108 492.8, filed Mar. 25, 2024, the entire contents of which are hereby incorporated by reference.

### TECHNICAL FIELD

The present disclosure relates to a circuit, a method and a system for balancing the voltage of storage units.

### BACKGROUND

For operating an electric boat drive, the electrical energy is typically stored in electrochemical battery cells. It is known to combine and interconnect these battery cells with one another in different configurations in order to achieve both the electrical performance parameters such as the desired terminal voltage and capacity of the energy storage device, and also to take account of the structural conditions by means of a corresponding form factor. Further parameters for the design and construction of the energy storage device also relate to the ambient conditions such as, for example, the available charging infrastructure or the usual ambient temperatures.

In battery technology, a distinction is made between different structural storage units. The base unit is always the battery cell—in this case, cylindrical cells, prismatic cells and pouch cells are distinguished from one another. A battery module can be a series connection and/or parallel connection of battery cells, wherein a battery module typically also comprises a monitoring sensor system for the battery cells besides a mechanical structure and a contacting of the battery cells. A battery can be a series connection and/or a parallel connection of battery modules and also comprise a temperature control and a contacting besides a mechanical structure. A battery bank can comprise a plurality of batteries which are connected in series and/or parallel.

In the case of battery modules for the marine sector, efforts are generally made to select the number of battery cells such that a characteristic voltage level in the range of the protective low voltage is achieved. The protective low voltage is referred to the voltage which is so low that the user does not receive an electrical shock in the event of an accidental contact.

In the case of the use of lithium-ion cells, typical battery modules consist of 6 cells for 24V batteries or of 12 cells for 48V batteries. In the case of the use of lithium-iron phosphate cells, 7 cells for 24V batteries and 14 cells for 48V batteries are frequently used due to the lower cell voltage.

The battery cells connected in series in a module are all passed through by the same current. Since the battery cells are subject to a variation with respect to internal resistance and capacity, different terminal voltages (current not equal to zero) and subsequently different open-circuit voltages (current equal to zero) occur both dynamically (current greater or less than zero) and thereafter also statically (current equal to zero) in spite of the same current flow during charging and discharging.

If the internal resistance of the battery cells shows a temperature dependence, the different heating of individual battery cells can also lead to a different state of charge of these battery cells or to a different battery cell voltage.

The voltage difference between the battery cells is not recognizable from the external voltage of a battery module, since the battery module only outputs the entire voltage of all battery cells interconnected with one another. The safe and efficient operation of a battery module therefore requires a voltage synchronization of the battery cells. In the case of a safe voltage synchronization of the battery cells, a battery module can be charged up to the multiple of the battery cell charge end voltage, which corresponds to the number of battery cells connected in series, or can be discharged to the same multiple of the battery cell discharge end voltage without damage to the individual battery cells occurring.

If, on the other hand, the voltage synchronization of the battery cells is not ensured, individual battery cells can be overcharged or deeply discharged depending on the mode of operation while other battery cells are still moving in the permissible voltage range in the case of a constant battery module voltage.

The equality of the battery cell voltage within the scope of a permissible tolerance must at least be monitored in order to prevent battery cell damage. This task is typically performed by a battery management system, BMS, provided in the respective battery. Powerful BMS ensure with an active or passive balancing that different voltages of battery cells which are located within a battery module in a series connection are compensated. However, it should be noted that in the case of passive balancing, for example with the parallel connection of resistors to the battery cells/the battery cell which have an excessively high voltage, only very small discharge powers can be achieved due to the limited installation space and the balancing process can thus take several days.

In contrast, active balancing in which energy can be drawn from individual battery cells and supplied to other battery cells by the use of clocked circuits is very cost-intensive and involves space disadvantages.

Within a battery, the equalization of the cell voltages is normally organized across modules so that all battery cells move within a narrow tolerance of the cell voltage even at battery voltages of approximately 400V (series connection of 96 cells or of 8 modules with 12 cells each).

However, a voltage of 400V is not optimal for the realization of system powers of several 100 kW. The aim is, for example, the doubling of the system voltage, for example by means of a series connection of two 400V batteries.

In this case, balancing between the battery cells of the different batteries is not possible by means of the respective internal BMS provided in the batteries. There is therefore a need for balancing at system level or for a universal circuit for balancing the voltage of storage units.

### SUMMARY OF THE INVENTION

In view of the foregoing, it is an object of the exemplary aspects of the present disclosure to provide improved circuits for balancing the voltage of storage units, and a corresponding method and a corresponding system.

The object is solved by a circuit for balancing the voltages of storage units having the features of claim 1. Advantageous embodiments result from the dependent claims, the description and the figures.

Correspondingly, a circuit for balancing the voltage of storage units is proposed, comprising N storage units BT(1), . . . , BT(N), wherein N is a natural number greater than or equal to 2, wherein 1<=i<=N, wherein each storage unit BT(i) has a first pole and a second pole. The N storage units are connected in series so that the second pole of the i-th storage unit BT(i) is connected to the first pole of the i+1-th storage unit BT(i+1).

The circuit further comprises N+1 horizontal switches SH(1), . . . , SH(N+1) and N vertical switches SV(1), . . . , SV(N). The first pole of the i-th storage unit BT(i) is separably connected to the vertical switch SV(i) via a first horizontal switch SH(i). The second pole of the i-th storage unit BT(i) is separably connected to the vertical switch SV(i) via a second horizontal switch SH(i+1). The first horizontal switch SH(i) is separably connected to the second horizontal switch SH(i+1) via the vertical switch SV(i).

The circuit further comprises a balancing source having a first pole and a second pole. The first pole of the balancing source is separably connected to the first pole of the first storage unit BT(1) via the first horizontal switch SH(1). The second pole of the balancing source is separably connected to the second pole of the last storage unit BT(N) via the last horizontal switch SH(N+1).

The i-th storage unit BT(i) is connected to the balancing source by closing the horizontal switches SH(i) and SH(i+1), as well as by closing all vertical switches SV(1), . . . , SV(i−1), SV(i+1), . . . , SV(N).

Thereby, the voltage of the i-th storage unit BT(i) is adjusted, whereby the voltages of the storage units BT(1), . . . , BT(N) are balanced.

In other words, the circuit proposed here can be understood as a kind of ladder network in which the horizontal switches form the rungs of the ladder and a storage unit is respectively arranged on the first rail of the ladder between the rungs and a vertical switch is respectively arranged on the second rail between the rungs.

The first rail is hereby connected to a load, for example an electric motor or a heater, via the first pole of the first storage unit and the last pole of the last storage unit. Since the storage units are connected in series, the voltages of the respective storage units add up.

By actuating the horizontal switches, specific poles of the storage units can be connected to the opposite rail of the ladder. The specific poles of the storage units can finally be connected to the balancing source via the vertical switches.

For example, a 1600 Vdc grid can be generated by a series connection of four 400 Vdc storage units. Particularly for local energy storage devices, which provide a different number of storage units depending on the storage requirement, a scalable circuit can thus be provided, which balances the voltages of the storage units.

In the exemplary aspects of the present disclosure described herein, the first poles can be the positive poles and the second poles can be the negative poles of the storage units or of the balancing source.

The switches SV(1), . . . , SV(N), SH(1), . . . , SH(N) can be bidirectionally blockable.

A switch is bidirectionally blockable if it does not allow a current flow in both directions in a switched-off state.

Thereby, an unwanted current flow from the balancing source to the storage units or from the storage units to the balancing source can be effectively suppressed.

At least one of the switches SV(1), . . . , SV(N), SH(1), . . . , SH(N) can be a mechanical switch. In such a case, a bidirectional blocking capability is also ensured by mechanical separation of the conductors.

At least one of the switches SV(1), . . . , SV(N), SH(1), . . . , SH(N) can be an anti-serial arrangement of two transistors, particularly of MOSFET.

In the case of power transistors, due to the design, a parasitic diode is created between the source terminal and the drain terminal, which allows a current flow in a forward direction of the parasitic diode even in a switched-off state. In the case of reverse-conducting IGBT (insulated-gate bipolar transistor), such a diode is inserted between the emitter terminal and the collector terminal as an additional “die”. If two such power transistors are connected anti-serially to one another, the diodes also have anti-parallel forward directions. In this case, a current flow in the switched-off state is effectively suppressed. By simultaneously connecting the gate terminal, both transistors are switched simultaneously, so that a current flow is made possible.

The object set out above is furthermore solved by a reduced circuit for balancing the voltage of storage units having the features of claim 4. Advantageous embodiments of the method result from the dependent claims as well as the present description and the figures.

Correspondingly, a reduced circuit for balancing the voltage of storage units is proposed, comprising K first storage units BT(1,1), . . . , BT(K,1) and K second storage units BT(1,2), . . . , BT(K,2). Hereby, for all j=1, . . . , K:

Each of the storage units BT(j,1), BT(j,2) has a first pole and a second pole. The first storage unit BT(j,1) and the second storage unit BT(j,2) are connected in pairs in series so that the second pole of the first storage unit BT(j,1) is connected to the first pole of the second storage unit BT(j,2). The storage units BT(j,1), BT(j,2) connected in pairs in series form a 2S-KP network.

Further, the circuit comprises K first vertical switches SV(1,1), . . . , SV(K,1) and K second vertical switches SV(1,2), . . . , SV(K,2), as well as a first diode and a second diode. Hereby, for all j=1, . . . , K:

The first pole of the first storage unit BT(j,1) is connected to the cathode of the first diode. The anode of the first diode is separably connected to the second pole of the first storage unit BT(j,1) via the first vertical switch SV(j,1). The second pole of the second storage units BT(j,2) is connected to the anode of the second diode. The cathode of the second diode is separably connected to the first pole of the second storage unit BT(j,2) via the second vertical switch SV(j,2).

Further, the circuit comprises a balancing source having a first pole and a second pole, wherein the first pole of the balancing source is connected to the anode of the first diode and wherein the second pole of the balancing source is connected to the cathode of the second diode, wherein the first poles are the positive poles and the second poles are the negative poles of storage units and balancing source.

For all j=1, . . . , K, by closing the first vertical switch SV(j,1), the second storage unit BT(j,2) is connected to the balancing source (SY), or by closing the second vertical switch SV(j,2), the first storage unit BT(j,1) is connected to the balancing source (SY). Thereby, the voltage of the second storage unit BT(j,2) or of the first storage unit BT(j,1) is adjusted, whereby the voltages of the storage units are balanced.

For the case K=1, a particularly simple circuit results, wherein the indices then reduce from BT(1,1) and BT(1,2) to BT(1) and BT(2).

In the present case, the current direction is predetermined by the arrangement of the diodes and the balancing source. Particularly, horizontal switches can thereby be dispensed with. An adjustment of the voltage of the respective storage units only takes place via a single vertical switch.

The vertical switches of the reduced circuit can be unidirectionally blockable if the cells BT(j,k) function as sinks and the balancing source as source.

The current direction in the circuit is namely predetermined by the first and second diode, so that the switches subsequently only have to limit the current flow in one direction. The circuit can thereby in turn be simplified.

If the balancing source is to operate as sink, however, the vertical switches must be bidirectionally blockable.

At least one of the vertical switches can be a mechanical switch. The mechanical switches are bidirectionally blockable and thus also block a unidirectional current flow reliably.

At least one of the vertical switches can be a transistor, particularly a MOSFET. MOSFETs are unidirectionally blockable, as are IGBTs with anti-parallel diode, so that in the reduced circuit a single transistor can replace a vertical switch. Thereby, the reduced circuit is simplified and particularly also mechanically robust, since only an electronic switching of the switches can take place.

Both in the case of the general circuit and in the case of the reduced circuit, each storage unit can be a battery or be a battery module or be a battery cell.

The storage units can be based on iron phosphate or include iron phosphate. The storage units can be based on lithium ions or include lithium ions. However, the storage units can also comprise a solid electrolyte.

Each storage unit can have a voltage of 400 Vdc. Particularly, by using two 400 Vdc storage units, an 800 Vdc system can be provided.

The balancing source can be supplied potential-free from the series connection of the storage units. As a result, the entire series and parallel connection or the entire battery bank can provide energy for the balancing source.

The balancing source can be fed from one of the storage units of the series connection or is fed from an external energy source, particularly from the grid. For example, the balancing source can be fed from the storage unit with the greatest voltage.

The object set out above is furthermore solved by a method for balancing the voltage of storage units having the features of claim 11. Advantageous embodiments of the method result from the dependent claims as well as the present description and the figures.

Accordingly, a method for balancing the voltage of storage units is proposed. The method relates hereby to one of the aforementioned circuits or reduced circuits. In a first method step, at least one storage unit to be adjusted is determined by a management system. In a second method step, the storage unit to be adjusted is connected to the balancing source. Thereby, the voltage of the at least one storage unit to be adjusted is adjusted, whereby the voltages of the storage units are balanced.

The management system is hereby adapted to measure the voltage of the different storage units. By a comparison of the measured voltages, a storage unit can be determined, the voltage of which has to be adjusted. The management system is also adapted to switch the corresponding switches of the circuit, so that the storage unit to be adjusted is connected to the balancing source.

The storage unit to be adjusted can be the storage unit with the highest or the lowest voltage.

Thereby, a balancing of the voltages is achieved, in that the storage units with the extreme voltage values are adjusted. Thereby, on the whole, a more uniform voltage distribution and thus a balancing of the voltages is achieved.

For example, the second method step can also involve that the voltage of the storage unit with the lowest voltage is adjusted and subsequently the voltage of the storage unit with the highest voltage is adjusted, or vice versa.

The voltage level of the balancing source can hereby be adjusted to the voltage of the storage unit to be adjusted.

For example, the voltage of the balancing source can be adjusted to the end-of-charge voltage of the smallest unit to be balanced, i.e. battery voltage or module voltage or cell voltage. The method thereby allows that the voltage symmetry can be set at any desired state of charge of the series connection of storage units.

The voltage of the storage unit can be adjusted by the CCCV method in an exemplary aspect.

In the case of the CCCV method, in a first phase the voltage of the storage unit is adjusted by a constant current (CC). In a further phase, the voltage of the storage unit is adjusted by a constant voltage (CV).

The at least one storage unit to be adjusted can be disconnected from the balancing source after termination of the balancing of the voltages of the storage units. The adjustment of the voltage is thereby interrupted. Particularly, the change of the voltage can also be monitored by the management system and thus compare the target voltage of the storage unit with the actual voltage.

The balancing source can have a balancing current regulating device which is adapted to control the balancing current to zero before one of the switches is opened. Thereby, a current flow is prevented before the switch is opened.

The balancing of the voltages of the storage units can be terminated, for example, when the relative voltage difference of the storage units is less than 10%, particularly less than 1%.

The relative voltage difference can be particularly characterized by the quotient of the greatest voltage and the smallest voltage. However, it is also possible that the relative voltage difference is determined depending on the median voltage or the average voltage.

The object set out above is furthermore solved by means of a system for balancing the voltage of storage units having the features of claim 17. Advantageous embodiments of the method result from the dependent claims as well as the present description and the figures.

Accordingly, a system for balancing the voltage of storage units is proposed. The system comprises at least two storage units, a balancing source and at least one management system. The storage units are connected in series, wherein the storage units are separably connected to the balancing source. According to the exemplary aspects of the present disclosure, the storage units are separably connected to the balancing source by means of one of the aforementioned circuits.

### BRIEF DESCRIPTION OF THE DRAWING

Exemplary embodiments of the disclosure are explained in more detail by the following description of the figures. In the figures:

FIGS. 1A, B illustrate a circuit diagram of the circuit according to an exemplary aspect;

FIG. 2 shows a circuit diagram of an arrangement of MOSFETS;

FIG. 3 shows a circuit diagram of the reduced circuit according to an exemplary aspect in 2S-1P configuration;

FIG. 4 shows a circuit diagram of the reduced circuit according to an exemplary aspect in 2S-KP configuration; and

FIG. 5 shows a further circuit diagram of the reduced circuit according to an exemplary aspect in 2S-KP configuration.

### DETAILED DESCRIPTION

In the following, exemplary embodiments are described with reference to the figures. Thereby, identical, similar or identically acting elements are provided with identical reference numerals in the different figures and a repeated description of these elements is partially dispensed with in order to avoid redundancies.

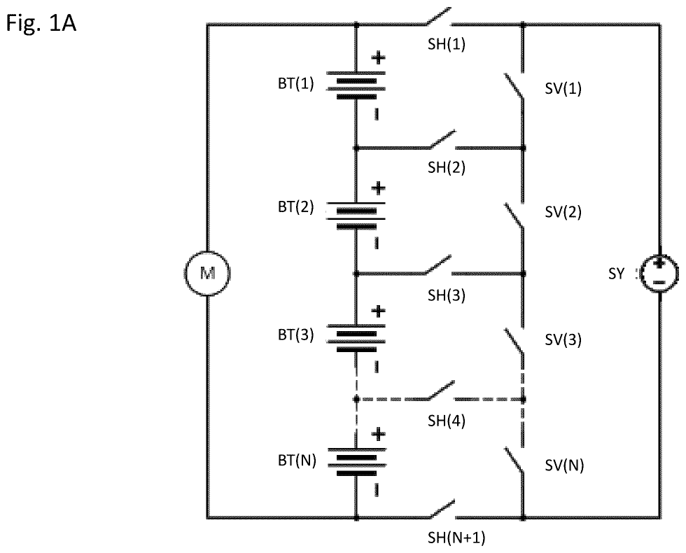

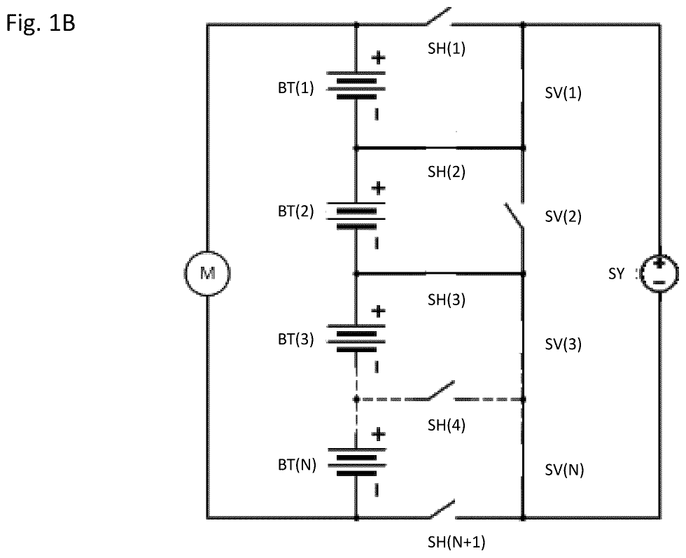

FIG. 1A shows a first aspect of the proposed circuit. Shown is an embodiment of the circuit for balancing the voltage of storage units, here in the form of batteries BT(1) to BT(N), wherein N is greater than or equal to 2. Each of the shown batteries BT(1) to BT(N) has a first pole and a second pole, wherein for example the first pole is the positive pole (+) and the second pole is the negative pole (−).

The batteries BT(1), . . . , BT(N) are here connected in series so that the second pole, here the negative pole (−), of the i-th battery BT(i) is connected to the first pole, here the positive pole (+), of the i+1-th battery BT(i+1). For example, the negative pole (−) of the first battery BT1 is connected to the positive pole (+) of the second battery BT2.

The series connection of batteries BT(1), . . . , BT(N) which together form a battery bank or a battery system can, for example, be connected to an electric machine M. Instead of the electric machine M, however, another load, such as a heater, can also be connected. Instead of a load, however, a source of energy, such as a charger, can also be connected.

The circuit now proposed can, however, be operated independently of the connected load.

The circuit comprises N+1 horizontal switches SH(1), . . . , SH(N+1) and N vertical switches SV(1), . . . , SV(N). The first pole of the i-th battery BT(i) can be separably connected to the vertical switch SV(i) via a first horizontal switch SH(i). The second pole of the i-th battery BT(i) can be separably connected to the vertical switch SV(i) via a second horizontal switch SH(i+1). The first horizontal switch SH(i) can be separably connected to the second horizontal switch SH(i+1) via the vertical switch SV(i).

Thereby, on the whole, a ladder-like arrangement results in which the rungs of the ladder are the horizontal switches SV(1), . . . , SV(N+1). On the first rail of the ladder, the batteries BT(1), . . . , BT(N) are located between the rungs. On the second rail of the ladder, the vertical switches SV(1), . . . , SV(N) are located between the rungs.

In order to now achieve a balancing of the battery cells of the batteries BT(1), . . . , BT(N), a balancing source SY is provided. The first pole of the balancing source SY is separably connected to the first pole of the first storage unit BT(1) via the first horizontal switch SH(1). The second pole of the balancing source SY is separably connected to the second pole of the N-th storage unit BT(N) via the last horizontal switch SH(N+1).

In order to charge or discharge a specific battery BT(i), the corresponding battery BT(i) is connected to the balancing source SY. Hierzu werden die horizontalen Schalter SH(i) und SH(i+1) geschlossen, sowie alle vertikalen Schalter SV(1), . . . , SV(i−1), SV(i+1), . . . , SV(N).

FIG. 1B shows an example of how the battery BT(2) is charged. For example, the battery BT(2) has the greatest or the smallest voltage of all batteries and must accordingly be charged or discharged in order to change the voltage and thus balance the battery system.

In order to change the voltage of the storage unit BT(2), the adjacent horizontal switches SH(2) and SH(3) must be closed. Likewise, the vertical switches SV(1), SV(3), . . . , SV(N) must be closed. Thus, it is ensured that the current from the balancing source SY flows exclusively through the battery BT(2). With an adjusted voltage value of SY, particularly a higher voltage value, a plurality of batteries can also be recharged or discharged simultaneously. Thus, only one battery or up to N batteries can be recharged or discharged together. However, only the batteries can be recharged together which are electrically connected to each other in an immediate sequence directly, i.e. without switches.

Generally speaking, for a topology according to FIG. 1A, it can thus be said that for changing the voltage of the i-th battery BT(i), the closing of the horizontal switches SH(i) and SH(i+1) as well as of all vertical switches with the exception of the switch SV(i) is necessary.

If the batteries BT are to be able to be both charged and discharged individually, it is advantageous if all horizontal switches and vertical switches are bidirectionally blockable. For example, a mechanical switch is bidirectionally blockable.

In the case of the use of power semiconductors instead of mechanical switches, an anti-serial circuit possibly has to be used for ensuring the bidirectional blocking capability. If MOSFETs are used as power semiconductors, they have, for example, a parasitic anti-parallel diode, so that no blocking capability exists in diode forward direction. The MOSFETs are accordingly not bidirectionally blockable, but only unidirectionally blockable.

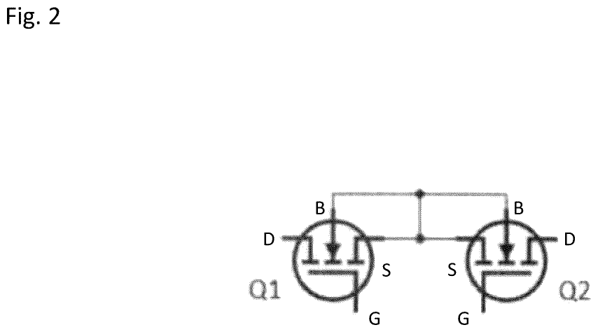

FIG. 2 shows a possible equivalent circuit of a bidirectionally blockable switch, which is based on a first MOSFET Q 1 and a second MOSFET Q 2. Hereby, the source terminals S and the base terminals B of the two MOSFETs are connected to one another. Thereby, it is prevented that a current in each case can flow from the source terminal S to the drain terminal D. A current flow can thus be realized exclusively when the gate terminal G is supplied with current. A circuit in which the drains of the MOSFETs are connected to one another and the sources of the MOSFETs form the connection points for the connected circuit has the same effect.

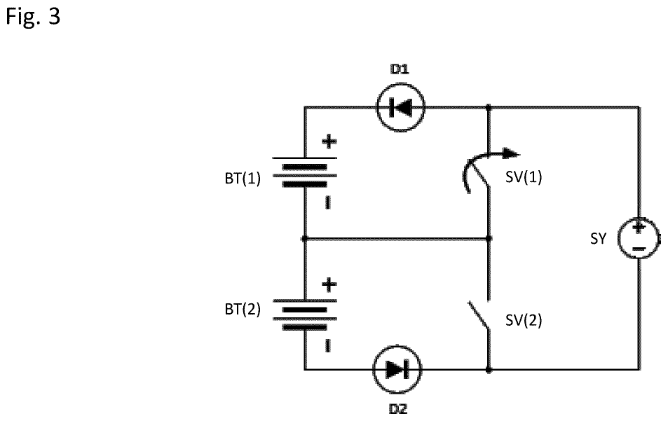

In FIG. 3, a circuit for balancing the voltage of two storage units BT 1 and BT 2 is shown. The circuit results from the above-described reduced circuit for the case K=1.

If it is namely assumed that only the voltage of the battery with the lowest energy is to be increased, the circuit of FIG. 1 can be drastically simplified.

The reduced circuit for balancing the voltage of storage units comprises a first storage unit BT(1) and a second storage unit BT(2), wherein each of the two storage units BT(1), BT(2) has a first pole (+) and a second pole (−). The first storage unit BT(1) and the second storage unit BT(2) are connected in series so that the second pole of the first storage unit BT(1) is connected to the first pole of the second storage unit BT(2).

Further, the reduced circuit comprises a first vertical switch SV(1) and a second vertical switch SV(2), as well as a first diode D1 and a second diode D2.

The first pole of the first storage unit BT(1) is connected to the cathode of the first diode D1, wherein the anode of the first diode D1 is separably connected to the second pole of the first storage unit BT(1) via the first vertical switch SV(1).

The second pole of the second storage unit BT(2) is connected to the anode of the second diode D2, wherein the cathode of the second diode D2 is separably connected to the first pole of the second battery BT(2) via the second vertical switch SV(2).

The first pole of the balancing source SY is connected to the anode of the first diode D1 and the second pole of the balancing source SY is connected to the cathode of the second diode D2. Tthe first poles are hereby the positive poles and the second poles are the negative poles of the batteries BT and of the balancing source SY.

Firstly, compared to FIG. 1, the horizontal switches SH(1) and SH(N+1) in the outermost rungs of the ladder circuit can therefore be replaced by a first diode D1 and a second diode D2. If only unidirectionally blocking vertical switches are implemented, the circuit is limited to charging one or more of the batteries by means of the balancing source SY. A discharging of one or more batteries by means of the balancing source SY is not possible in this way.

The first diode D1 and the second diode D2 are hereby arranged in a forward direction to the balancing source SY. At the same time, the first diode D1 is arranged in a reverse direction to the first battery BT(1) and the second diode D2 is arranged in a reverse direction to the second battery BT(2).

By replacing switches with diodes, the driving effort of the circuit can be reduced.

Since only two batteries are installed and the current direction of the balancing source SY is predetermined, a complete dispensation of horizontal switches SH is possible compared to FIG. 1.

FIG. 3 further shows schematically the recharging of the battery BT(2), which can be achieved by closing the switch SV(1). If the battery BT1 is to be recharged, SV(1) must be opened and SV(2) must be closed.

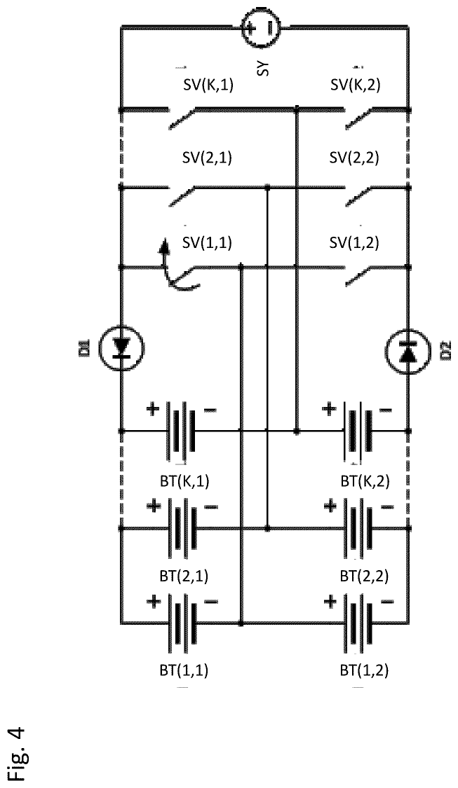

FIG. 4 shows the general case of the reduced circuit for a 2S-KP configuration. The reduced circuit for balancing the voltage of batteries BT comprises K first batteries BT(1,1), . . . , BT(K,1) and K second batteries BT(1,2), . . . , BT(K,2). For all j=1, . . . , K, each of the batteries BT(j,1), BT(j,2) has a first pole and a second pole. The first battery BT(j,1) and the second battery BT(j,2) are connected in pairs in series so that the second pole of the first battery BT(j,1) is connected to the first pole of the second battery BT(j,2). The batteries BT connected in pairs in series form a 2S-KP network.

Further, the circuit comprises K first vertical switches SV(1,1), . . . , SV(K,1) and K second vertical switches SV(1,2), . . . , SV(K,2), as well as a first diode D1 and a second diode D2. Hereby, for all j=1, . . . , K, the first pole of the first battery BT(j,1) is connected to the cathode of the first diode. The anode of the first diode is separably connected to the second pole of the first battery BT(j,1) via the first vertical switch SV(j,1). The second pole of the second battery BT(j,2) is connected to the anode of the second diode. The cathode of the second diode is separably connected to the first pole of the second battery BT(j,2) via the second vertical switch SV(j,2).

Further, the circuit comprises a balancing source SY having a first pole and a second pole, wherein the first pole of the balancing source SY is connected to the anode of the first diode and wherein the second pole of the balancing source SY is connected to the cathode of the second diode, wherein the first poles are the positive poles and the second poles are the negative poles of storage units and balancing source SY.

For all j=1, . . . K, by closing the first vertical switch SV(j,1), the second battery BT(j,2) is connected to the balancing source (SY), or by closing the second vertical switch SV(j,2), the first battery BT(j,1) is connected to the balancing source SY. Thereby, the voltage of the second battery BT(j,2) or of the first battery BT(j,1) is adjusted, whereby the voltages of the batteries BT are balanced.

With a balancing source SY and two diodes D1, D2, K-two-stage battery strings having an associated switch half-bridge can be managed.

For this purpose, the K-two-stage battery strings BT(j,1), BT(j,2) are connected in parallel. Likewise, the associated strings of vertical switches SV(j,1), SV(j,2) connected in series are connected in parallel. The parallel-connected battery strings and vertical switch strings are finally connected to the first and the second diode and the balancing source SY in the manner described above.

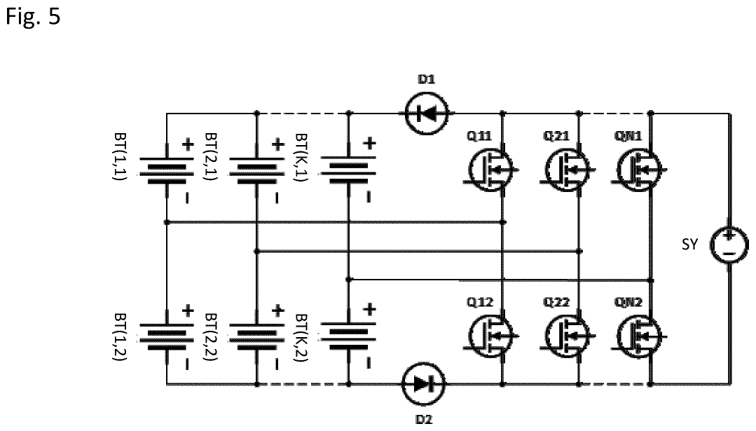

FIG. 5 shows an equivalent circuit if the switches of the circuit of FIG. 4 are replaced by unidirectionally blockable switches Q. Since the switches only have to block the current in one direction, it is possible to use any switch which can block voltage unidirectionally. For example, MOSFETs can be used as replacements for the switches.

With the circuits shown, a method for balancing can be carried out (not shown). Hereby, a management system can be adapted to measure the voltage of the respective batteries and to determine the battery to be adjusted. The battery to be adjusted can finally be connected to the balancing source SY by controlling the switches by means of the management system, so that the voltage of the battery to be adjusted can be adjusted. If the voltage of the battery to be adjusted is within a predetermined tolerance range, the battery to be adjusted can be disconnected from the balancing source SY. After adjusting the voltage, for example, the difference of the battery with the highest voltage and the difference of the battery with the lowest voltage is smaller. Thereby, the voltages of the batteries are balanced.

As far as applicable, all individual features shown in the example embodiments can be combined with one another and/or exchanged without departing from the scope of the invention.

### REFERENCE SIGNS

BT storage unit
D Diode
Q MOSFET/power transistor
SY Balancing source
SH Horizontal switch
SV Vertical switch

What is claimed:

1. A circuit for balancing a voltage of storage units, the circuit comprising:
N storage units BT(1), . . . , BT(N), wherein:
N is greater than or equal to 2,
each storage unit BT(i) has a first pole and a second pole,
the N storage units are connected in series so that the second pole of the i-th storage unit BT(i) is connected to the first pole of the i+1-th storage unit BT(I+1);
N+1 horizontal switches SH(1), . . . , SH(N+1) and N vertical switches SV(1), . . . , SV(N), wherein:
the first pole of the i-th storage unit BT(i) is separably connected to the vertical switch SV(i) via a first horizontal switch SH(i),
the second pole of the i-th storage unit BT(i) is separably connected to the vertical switch SV(i) via a second horizontal switch SH(i+1),
the first horizontal switch SH(i) is separably connected to the second horizontal switch SH(i+1) via the vertical switch SV(i); and
a balancing source (SY) having a first pole and a second pole,
wherein the first pole of the balancing source (SY) is separably connected to the first pole of the first storage unit BT(1) via the first horizontal switch SH(1),
wherein the second pole of the balancing source (SY) is separably connected to the second pole of the N-th storage unit BT(N) via the last horizontal switch SH(N+1),
wherein the i-th storage unit BT(i) is connected to the balancing source (SY) by closing the horizontal switches SH(i) and SH(i+1), as well as by closing all vertical switches SV(1) to SV(i−1) as well as SV(i+1) to SV(N), and
wherein the voltage of the i-th storage unit BT(i) is adjusted, whereby the voltages of the storage units BT(1), . . . , BT(N) is balanced.

2. The circuit according to claim 1, wherein the switches SV(1), . . . , SV(N), SH(1), . . . , SH(N) are bidirectionally blockable.

3. The circuit according to claim 1, wherein
at least one switch SV(1), . . . , SV(N), SH(1), . . . , SH(N) is a mechanical switch or
at least one switch SV(1), . . . , SV(N), SH(1), . . . , SH(N) is an anti-serial arrangement of two transistors.

4. The circuit according to claim 1, wherein each storage unit (BT) is a battery or is a battery module or is a battery cell.

5. The circuit according to claim 1, wherein the storage unit (BT) is based on iron phosphate or includes iron phosphate or is based on a solid electrolyte.

6. The circuit according to claim 1, wherein each storage unit (BT) has a voltage of 400 Vdc.

7. The circuit according to claim 1, wherein the balancing source (SY) is supplied potential-free from the series connection of the storage units (BT) or the balancing source (SY) is fed from one of the storage units (BT) of the series connection or is fed from an external energy source.

8. A circuit for balancing the voltage of storage units (BT), the circuit comprising:
K first storage units BT(1,1), . . . , BT(K,1) and K second storage units BT(1,2), . . . , BT(K,2), wherein for all j=1, . . . , K:
each first storage unit BT(j,1) and each second storage unit BT(j,2) has a first pole and a second pole,
the first storage unit BT(j,1) and the second storage unit BT(j,2) are connected in pairs in series so that the second pole of the first storage unit BT(j,1) is connected to the first pole of the second storage unit BT(j,2), and
the storage units BT(j,1), BT(j,2) connected in pairs in series form a 2S-KP network;
K first vertical switches SV(1,1), . . . , SV(K,1) and K second vertical switches SV(1,2), . . . , SV(K,2), as well as a first diode (D1) and a second diode (D2), wherein for all j=1, . . . , K:
the first pole of the first storage unit BT(j,1) is connected to the cathode of the first diode (D1),
the anode of the first diode (D1) is separably connected to the second pole of the first storage unit BT(j,1) via the first vertical switch SV(j,1),
the second pole of the second storage units BT(j,2) is connected to the anode of the second diode (D2), and
the cathode of the second diode (D2) is separably connected to the first pole of the second storage unit BT(j,2) via the second vertical switch SV(j,2); and
a balancing source (SY) having a first pole and a second pole, wherein:
the first pole of the balancing source (SY) is connected to the anode of the first diode (D1), and
the second pole of the balancing source (SY) is connected to the cathode of the second diode (D2), and
the first poles are the positive poles and the second poles are the negative poles of storage units (BT) and balancing source (SY),
wherein for all j=1, . . . K:
by closing the first vertical switch SV(j,1), the second storage unit BT(j,2) is connected to the balancing source (SY), or
by closing the second vertical switch SV(j,2), the first storage unit BT(j,1) is connected to the balancing source (SY), and
wherein the voltage of the second storage unit BT(j,2) or the first storage unit BT(j,1) is adjusted, and the voltages of the storage units (BT) is balanced.

9. The circuit according to claim 8, wherein the vertical switches (SV) are at least unidirectionally blockable.

10. The circuit according to claim 8, wherein at least one of the vertical switches (SV) is a mechanical switch or at least one of the vertical switches (SV) is a transistor.

11. The circuit according to claim 8, wherein each storage unit (BT) is a battery or is a battery module or is a battery cell.

12. The circuit according to claim 8, wherein the storage unit (BT) is based on iron phosphate or includes iron phosphate or is based on a solid electrolyte.

13. The circuit according to claim 8, wherein the balancing source (SY) is supplied potential-free from the series connection of the storage units (BT) or the balancing source (SY) is fed from one of the storage units (BT) of the series connection or is fed from an external energy source.

14. A method for balancing a voltage of storage units (BT) a circuit that includes:
N storage units BT(1), . . . , BT(N), wherein:
N is greater than or equal to 2,
each storage unit BT(i) has a first pole and a second pole,
the N storage units are connected in series so that the second pole of the i-th storage unit BT(i) is connected to the first pole of the i+1-th storage unit BT(I+1);
N+1 horizontal switches SH(1), . . . , SH(N+1) and N vertical switches SV(1), . . . , SV(N), wherein:
the first pole of the i-th storage unit BT(i) is separably connected to the vertical switch SV(i) via a first horizontal switch SH(i),
the second pole of the i-th storage unit BT(i) is separably connected to the vertical switch SV(i) via a second horizontal switch SH(i+1),
the first horizontal switch SH(i) is separably connected to the second horizontal switch SH(i+1) via the vertical switch SV(i); and
a balancing source (SY) having a first pole and a second pole,
wherein the first pole of the balancing source (SY) is separably connected to the first pole of the first storage unit BT(1) via the first horizontal switch SH(1),
wherein the second pole of the balancing source (SY) is separably connected to the second pole of the N-th storage unit BT(N) via the last horizontal switch SH(N+1),
wherein the i-th storage unit BT(i) is connected to the balancing source (SY) by closing the horizontal switches SH(i) and SH(i+1), as well as by closing all vertical switches SV(1) to SV(i−1) as well as SV(i+1) to SV(N), and
wherein the voltage of the i-th storage unit BT(i) is adjusted, whereby the voltages of the storage units BT(1), . . . , BT(N) is balanced,
wherein the method comprises:
adjusting at least one storage unit (BT′) by a management system;
connecting the at least one storage unit (BT′) to be adjusted to the balancing source (SY);
adjusting the voltage of the at least one storage unit (BT′); and
balancing the voltages of the storage units (BT).

15. The method according to claim 14, further comprising adjusting the voltage level of the balancing source (SY) to the voltage of the storage unit (BT′) to be adjusted.

16. The method according to claim 14, wherein the storage unit (BT′) to be adjusted is the storage unit with the highest or the lowest voltage.

17. The method according to claim 14, further comprising adjusting the voltage of the storage unit (BT′) to be adjusted by the CCCV method.

18. The method according to claim 14, further comprising disconnected the at least one storage unit (BT′) to be adjusted from the balancing source (SY) after termination of the balancing of the voltages of the storage units.

19. The method according to claim 18, further comprising terminating the balancing of the voltages of the storage units (BT) when the relative voltage difference of the storage units (BT) is less than 10%.

20. The method according to claim 14, further comprising recharging up to N storage units (BT) together, wherein the storage units (BT) are directly connected to each other in an electrically immediate sequence.
